(19) United States
(12) Patent Application Publication
(10) Pub. No.: US 2003/0177647 A1
(43) Pub. Date: Sep. 25, 2003

(54) Miniature roller plane for making precision cuts in flat and concave work surfaces

(76) Inventors: Edward M. Moore, Kingman, AZ (US); William H. Smedley, Kingman, AZ (US)

Correspondence Address: MORLAND C FISCHER, 2030 MAIN ST, SUITE 1050, IRVINE, CA, 92614

(21) Appl. No.: 10/372,476

(22) Filed: Feb. 25, 2003

Related U.S. Application Data
(60) Provisional application No. 60/365,721, filed on Mar. 20, 2002.

(51) Int. Cl. B27G 17/02

(52) U.S. Cl. 30/489

(57) ABSTRACT

A miniature roller plane for making fine cuts in straight and concave surfaces of a workpiece. The roller plane includes a mounting frame to move along the workpiece, a roller attached to the front of the mounting frame, and a threaded shaft projecting from the opposite end of the mounting frame to which a pushing force is applied. The roller at the front of the mounting frame may have a cylindrical or a barrel shaped configuration to facilitate the mounting frame riding over straight and concave surfaces. An adjustable cutting blade is slidable over a ramp face of the mounting frame. The position of the cutting blade along the ramp face is selectively adjusted with micrometer precision by way of a rotatable thumb nut that is coupled to and movable axially along the threaded shaft towards the cutting blade. Once the position of the cutting blade has been selected, a lock down bar applies a holding pressure against the cutting blade to prevent a further displacement of the cutting blade over the ramp face.

### CROSS-REFERENCE TO RELATED PATENT APPLICATION

This application is a continuation of Provisional Patent Application No. 60/365,721 filed Mar. 20, 2002.

### BACKGROUND OF THE INVENTION

1. Field of the Invention

This invention relates to a miniature roller plane having a roller located at the front end thereof and being particularly adapted to make precision cuts in a workpiece. The roller has either a cylindrical or a barrel shaped configuration to facilitate the plane riding over and making a smooth and controlled cut in both straight and concave surfaces of the workpiece.

2. Background Art

Miniature wood planes, commonly known as finger planes, have been used for many years to make cuts in small wooden objects, such as musical instruments, and the like. The finger plane typically includes a cutting blade that is slidable along a ramp body to assume a position suitable to cut a workpiece. The position of the cutting blade along the ramp body is adjustable depending upon the workpiece to be cut. The workman uses his thumb and fingers to grasp and push the finger plane across the workpiece.

However, the ability of the workman to generate the power necessary to cut hard woods is limited when the conventional finger plane is employed. In this case, the hand of the workman is known to experience early fatigue. What is more, no means have been associated with the conventional finger plane for assuring a smooth, even and controlled cut, particularly when fine detailed cuts must be made. In this same regard, while the position of the cutting blade of the conventional finger plane is slidably adjustable over the ramp body, such position adjustments cannot be accurately made in very small increments as would be necessary for making fine detailed cuts.

Accordingly, what is desirable is an improved miniature plane that is capable of generating more pushing power without significant user discomfort, providing a smooth, controlled cut, and allowing the position of the cutting blade to be selectively adjusted with micrometer precision.

### SUMMARY OF THE INVENTION

In general terms, a miniature roller plane is disclosed for making detailed cuts in straight and concave surfaces of a workpiece. The roller plane includes a mounting frame that is movable over the workpiece to be cut. A roller is attached to the front of the mounting frame to facilitate a smooth, controlled scooping action as the plane rides across the workpiece. The roller has a cylindrical or a barrel shaped configuration to enable the mounting frame to easily roll over straight and concave surfaces of the workpiece. In the case where a cylindrical roller is used, the bottom of the mounting frame is provided with a flat sole. In the case where a barrel shaped roller is used, the bottom of the mounting frame is provided with a curved sole. A threaded shaft projects outwardly from the back of the mounting frame to receive a pushing force for causing the mounting frame to ride across the workpiece. A threaded cutting blade adjustment nut is coupled to the threaded shaft projecting from the mounting frame.

The mounting frame of the miniature roller plane includes a ramp face positioned opposite the sole. An adjustable cutting blade is slidable over the ramp face of the mounting frame to cut the workpiece. The position of the cutting blade along the ramp face is selectively adjusted with micrometer precision. More particularly, a rotation of the threaded cutting blade adjustment thumb nut around the threaded shaft is translated into an axial displacement of the thumb nut along the shaft in a direction towards the cutting blade. The axial displacement of the thumb nut causes a corresponding linear displacement of the cutting blade over the ramp face of the mounting frame so that a sharp tip thereof is advanced outwardly from an exit slot at the front of the mounting frame. Once the desired position of the adjustable cutting blade has been selected, a lock down bar laying over top the cutting blade applies a holding pressure to prevent a further displacement of the cutting blade relative to the ramp face. That is, a thumb screw having a threaded shaft received through a threaded hole in the lock down plate is rotated for causing the threaded shaft to tighten down against the adjustable cutting blade lying under the lock down bar, whereby to prevent the cutting blade from sliding over the ramp face. A dowel pin extending laterally across the mounting frame is captured by a groove formed in the lock down bar to position and hold the lock down bar atop the cutting blade.

### BRIEF DESCRIPTION OF THE DRAWINGS

FIG. 1 is a perspective view of a miniature roller plane of this invention having a roller at the front end thereof,

FIG. 2 is a side view of the miniature roller plane shown in FIG. 1;

FIG. 3 is an exploded view of the miniature roller plane shown in FIG. 1;

FIG. 4 is a cross-section of the miniature roller plane shown in FIG. 1;

FIG. 5 is a side view of a modified roller plane;

FIG. 6 shows a detailed bottom view of the miniature roller plane having a barrel shaped roller and a curved bottom sole;

FIG. 7 is an end view taken in the direction indicated by the reference line marked 7 in FIG. 6;

FIG. 8 shows a detailed bottom view of the miniature roller plane having a cylindrical roller and a flat bottom sole; and

FIG. 9 is an end view taken in the direction indicated by the reference line marked 9 in FIG. 8.

### DETAILED DESCRIPTION

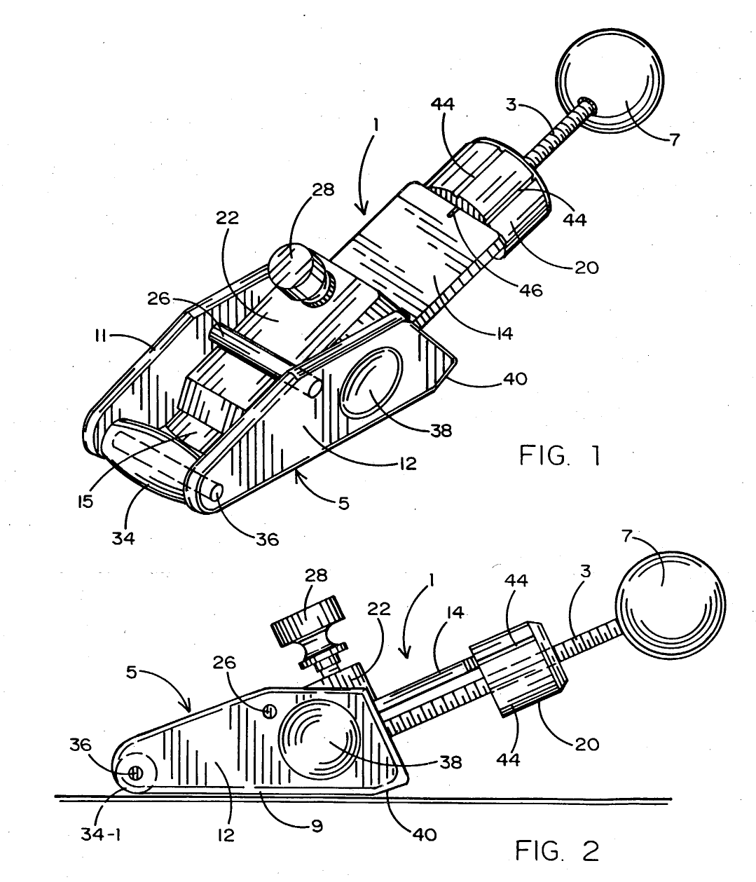

The miniature roller plane 1 of this invention for making detailed cuts in wooden workpieces is initially described while referring concurrently to FIGS. 1-5 of the drawings. In order to make small, delicate workpieces (e.g. a musical instrument), it is contemplated that the end-to-end length of the miniature roller plane 1 can be as little as about 10 cm. However, the precise length of roller plane 1 is not to be regarded as a limitation of this invention. Roller plane 1 includes an elongated threaded shaft 3 that is preferably manufactured from metal. The threaded shaft 3 extends between a mounting frame 5 and a palming ball 7. The palming ball 7 is typically manufactured from wood, metal or plastic and is sized to comfortably fit within the palm of a user's hand so that a sufficient pushing force may be generated by the user for moving the plane 1 along most workpieces, regardless of hardness. The threaded shaft 3 projects outwardly and rearwardly from the mounting frame 5 so as to make an angle of approximately 25 degrees with the horizontal.

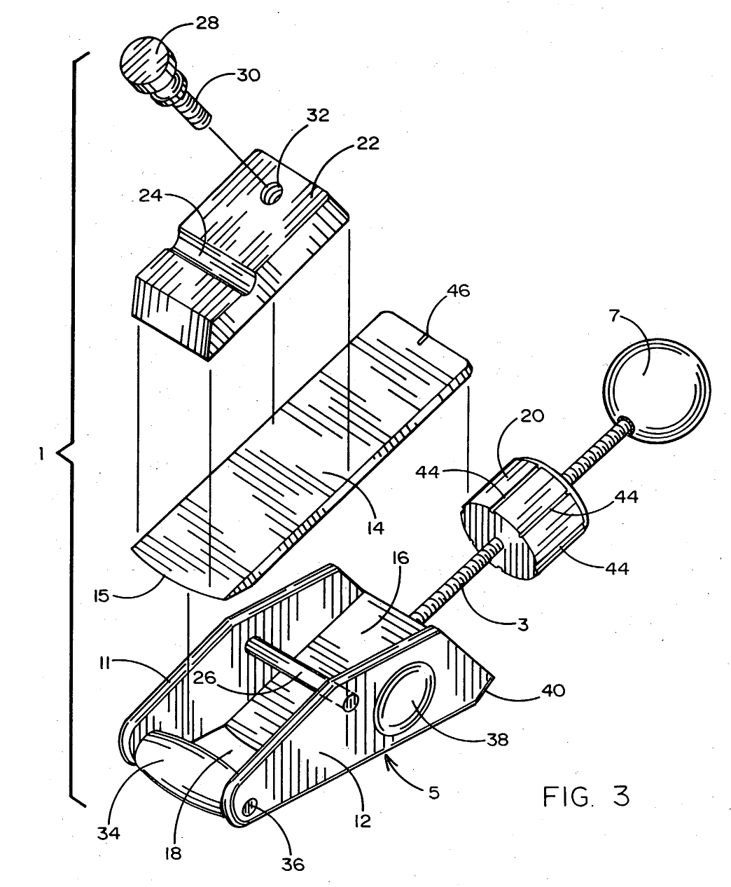

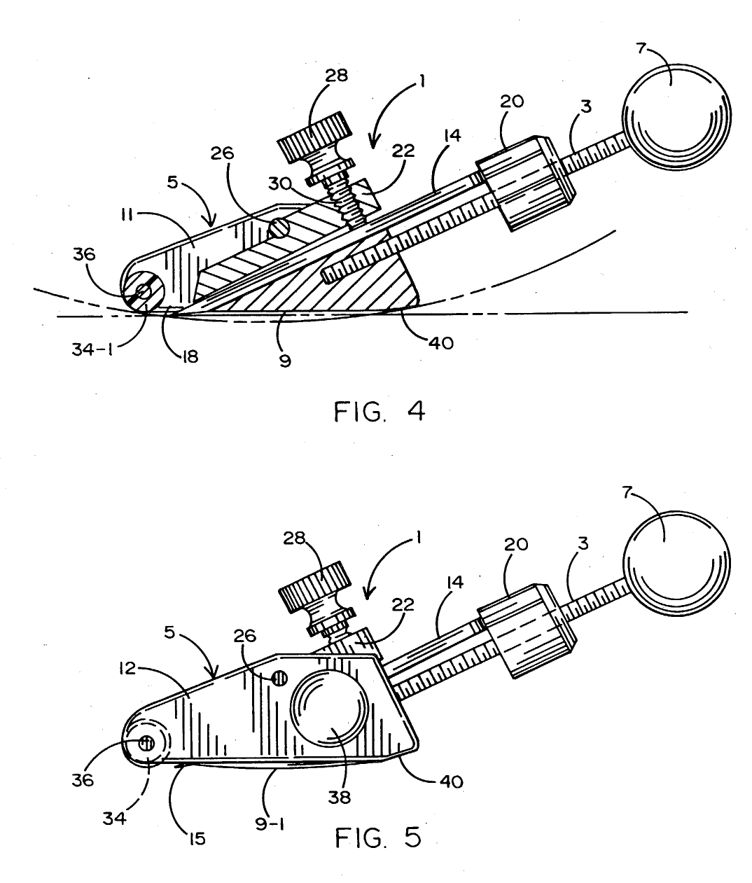

The mounting frame 5 of roller plane 1 is preferably manufactured from metal. The bottom of mounting frame 5 includes a sole at the underside thereof and a pair of walls 11 and 12 that are coextensively connected at opposite sides of the sole and turned upwardly therefrom. As will be explained in greater detail hereinafter, the bottom sole of roller plane 1 may either be flat (designed 9 in FIGS. 2 and 4) or curved (designed 9-1 in FIG. 5). As is best shown in FIG. 3, the side walls 11 and 12 of mounting frame 5 are arranged in spaced, parallel alignment with one another.

A position adjustable cutting blade 14 is slidably received against a ramp face 16 formed at the bottom of the mounting frame 5 (best shown in FIG. 3). The ramp face 16 and the cutting blade 14 that is slidable thereover make the same angle (e.g. 25 degrees) with the horizontal as the angle made by the threaded shaft 3. Ramp face 16 lies opposite the sole 9 at the underside of mounting frame 5 and extends between the spaced side walls 11 and 12. However, the ramp face 16 terminates at an exit slot 18 that is located at the front of roller plane 1 (also best shown in FIG. 3). In the assembled relationship of FIGS. 1 and 2, and as will soon be explained, the cutting blade 14 is slidable longitudinally along the ramp face 16 of mounting frame 5 so as to advance towards the exit slot 18 at the front of roller plane 1. That is, the position of cutting blade 14 along the ramp face 16 can be selectively adjusted so that a sharp tip 15 thereof will extend outwardly through the exit slot 18 by an amount that is necessary for cutting a surface of the workpiece.

To this end, a threaded cutting blade adjusting thumb nut 20 is coupled in surrounding engagement to the threaded shaft 3 of roller plane 1 so as to enable the user to make micrometer adjustments to the position of the adjustable cutting blade 14 along the ramp face 16. A rotational force applied by the user to the thumb nut 20 is translated into an axial displacement of thumb nut 20 along the threaded shaft 3 in a direction towards cutting blade 14. The actual direction in which the thumb nut 20 travels along threaded shaft 3 is dependent upon the direction in which thumb nut 20 is rotated. In this regard, with the thumb nut 20 being rotated in a first direction so as to move axially along threaded shaft 3 towards the adjustable cutting blade 14, a pushing force will be imparted by the thumb nut 20 to the cutting blade 14 so as to cause the cutting blade 14 to slide down the ramp face 16 of mounting frame 5 and outwardly through the exit slot 18, whereby the sharp tip 15 of the cutting blade 14 will be exposed for cutting a work surface. However, with the thumb nut 20 being rotated in an opposite direction so as to move axially along threaded shaft 3 away from the adjustable cutting blade 14, the adjustable cutting blade 14 can be manipulated by the user so as to slide up ramp face 5 in order to be retracted inwardly of the exit slot 18, whereby less (or none) of the sharp tip 15 of the cutting blade 18 will project outwardly from the exit slot 18 at the front of roller plane 1.

In order to maintain the desired position of the adjustable cutting blade 14 along ramp face 5, a cutting blade lock down bar 22 is laid over the cutting blade 14. As is best shown in FIG. 3, a laterally extending groove 24 is formed in the lock down bar 22. In the assembled relationship of FIGS. 1 and 2, a dowel pin 26 is captured by the groove 24 so that the position of lock down bar 22 within the mounting frame 5 of roller plane 1 will remain fixed atop cutting blade 14. The dowel pin 26 extends between the side walls 11 and 12 of mounting frame 5 for receipt by the groove 24 of lock down bar 22 to hold lock down bar 22 over blade 14.

Roller plane 1 is provided with a thumb screw 28 which is adapted to be rotated into locking engagement with the adjustable cutting blade 14 so as to maintain the position of cutting blade 14 at the desired location along the ramp face 16 of mounting frame 5. As is best shown in FIG. 3, a threaded shaft 30 of thumb screw 28 is received through a correspondingly threaded hole 32 that is formed in the cutting blade lock down bar 22. Depending upon the direction in which the thumb screw 28 is rotated, the threaded shaft 30 thereof will be moved either towards or away from the adjustable cutting blade 14 over which the lock down bar 22 is laid. Once the position of the cutting blade 14 relative to the exit slot 18 of roller plane 1 has been selectively adjusted, the thumb screw 26 is rotated in a direction so as to cause the shaft 30 to be tightened down against the cutting blade. Accordingly, the adjustable cutting blade 14 will be locked in place along the ramp face 16 of mounting frame 5 until such time as the thumb screw 28 is rotated in an opposite direction to loosen the locking engagement of the shaft 30 against the cutting blade 14 so as to enable the position of the cutting blade to be further adjusted.

Located at the front of the roller plane 1 ahead of the exit slot 18 is a roller 34. The roller 343 is preferably manufactured from an engineering grade plastic. Roller 34 is supported for rotation by an axle 36 that extends between the side walls 11 and 12 of the mounting frame 5. So as to avoid interfering with the sliding adjustment of the adjustable cutting blade 14 along the ramp face 16 and the advancement of the sharp tip 15 thereof outwardly from the exit slot 18, the exit slot 18 establishes a clearance of about 2.5 mm between the bottom of the roller 34 and the cutting blade (best shown in FIG. 4). What is more, the axle 36 is positioned across the mounting frame 5 so that the bottom of roller 34 lies slightly above the sole 9 at the underside of the mounting frame.

To facilitate the manipulation of the roller plane 1, a pair of finger wells 38 (only one of which being visible) are formed in respective side walls 11 and 12 of mounting frame 5 to receive the user's thumb of forefinger for the purpose of enabling the user to guide the roller plaine 1 along a surface of the workpiece to be cut by cutting blade 14. In order to be able to better manipulate the roller plane 1 for making cuts in a concave surface of the workpiece, a dishing ramp 40 is formed at the rear end of the sole 9 at the underside of mounting frame 5. The dishing ramp 40 makes a small angle (e.g. about 5 degrees) with the sole 9.

Referring specifically to FIG. 4 of the drawings, the roller plane 1 of this invention is shown for cutting either concave and straight surfaces of a workpiece. The inclusion of the roller 34 at the front of the mounting frame 5 to roll over the concave surface and the dishing ramp 40 at the rear of the mounting frame 5 to slide over the concave surface balances the mounting frame 5 and permits the roller plane 1 to be more easily guided around the concave surface for making fine cuts in the workpiece. More particularly, the combination of roller 34 and dishing ramp 40 at opposite ends of the mounting frame 5 enables a smooth, controlled and scooping action for cutting the entire concave surface, especially where such cut requires fine detail. The addition of roller 34 also enables the roller plane 1 to have a rocking motion to enable cuts to be more easily and comfortably made.

In order to maximize the ability of the roller plane 1 to make fine cuts in a concave surface of a workpiece, the flat sole 9 at the underside of the mounting frame 5 can be rounded. FIG. 5 of the drawings shows the roller plane 1 having a mounting frame 5 with such a round sole 9-1 in substitution of the aforementioned flat sole 9 so as to better conform to the concave shape of the work surface. Inasmuch as the remainder of the roller plane 1 has not been changed, the reference numerals illustrated in FIG. 5 are identical to those illustrated in FIGS. 1-4.

As is best shown in FIG. 3, the sharp tip 15 at the leading edge of cutting blade 14 is curved. In the preferred embodiment, the radius of curvature of cutting tip 15 matches the radius of curvature of the curved sole 9-1 at the underside along the bottom of mounting frame 5 of the roller plane 1 of FIG. 5.

To enable cutting adjustments to be made to the roller plane 1 with micrometer precision, the cutting blade adjustment thumb nut 20 can be scored with a series of evenly spaced index lines 44. In the present embodiment, the index lines are shown spaced from one another around the thumb nut 20 by 45 degrees. A reference line 46 is inscribed into the trailing edge of the adjustable cutting blade 14. The reference line 46 provides a visual frame of reference by which to enable users to accurately measure the rotation of thumb nut 20 for causing an axial displacement of thumb nut 20 along the threaded shaft 3 and a corresponding linear displacement of the cutting blade 14 over ramp face 16 and towards the exit slot 18 at the front of mounting frame 5.

In the present example, with the index lines 44 on the thumb nut 20 spaced 45 degrees apart, a rotation of thumb nut 20 between a successive pair of index lines 44 results in a four mil linear displacement of the cutting blade 14 towards exit slot 18. Of course, the rotational distance between the index lines 44 can be more or less than 45 degrees. For example, in the case where the index lines 44 are spaced 22.5 degrees apart, a rotation of thumb nut 20 between a successive pair of index lines 44 will result in a 2 mil linear displacement of cutting blade 14 towards exit slot 18.

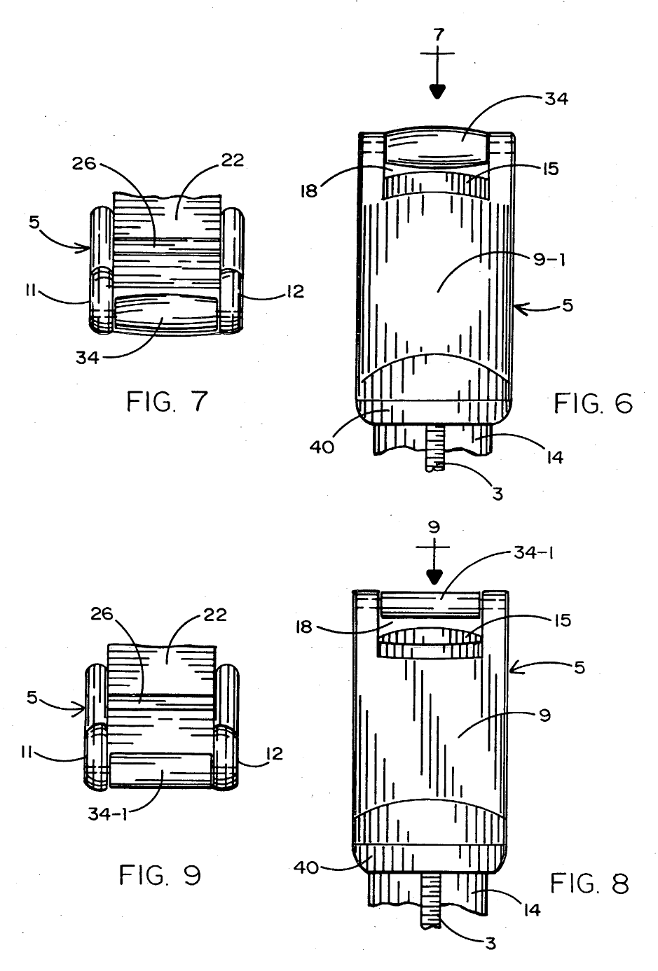

FIGS. 6 and 7 of the drawings show the bottom of a miniature roller plane 1 where the roller 34 has a generally barrel shape which is ideally suited for rolling over concave surfaces of the workpiece to be cut. In this case, the sole 9-1 at the underside of the mounting frame 5 will be curved. However, as shown in FIGS. 8 and 9 of the drawings, the roller 34-1 may also have a cylindrical configuration which is ideally suited for rolling over flat surfaces to be cut. In this case, the sole 9 at the underside of mounting frame 5 will be flat. As was previously described, the barrel shaped and cylindrical rollers 34 and 34-1 are sized so as to lie slightly above the curved and flat soles 9-1 and 9, whereby to provide a clearance to enable the sharp tip 15 of cutting blade 14 to advance outwardly from the exit slot 18 at the front of mounting frame 5.

We claim:

1. A plane for making cuts in a workpiece, said plane comprising:
a mounting frame to move along the workpiece to be cut;
a roller attached to one end of said mounting frame to roll over the workpiece to be cut;
a shaft projecting from the opposite end of the mounting frame to receive a pushing force for causing said mounting frame to move along the workpiece to be cut;
an adjustable cutting blade carried by the mounting frame for making cuts in the workpiece over which the mounting frame is moved; and
a cutting blade adjustment coupled to said shaft, said cutting blade adjustment adapted to be displaced relative to said shaft for causing a corresponding displacement of said adjustable cutting blade for cutting the workpiece.

2. The plane recited in claim 1, wherein said roller has a barrel shape for rolling over a curved surface of the workpiece to be cut.

3. The plane recited in claim 1, wherein said roller has a cylindrical shape for rolling over a flat surface of a workpiece to be cut.

4. The plane recited in claim 1, wherein said mounting frame includes a bottom sole having a top side and an underside and a pair of side walls projecting upwardly from said bottom sole in spaced alignment with one another, said roller lying between said pair of side walls.

5. The plane recited in claim 4, wherein the underside of the bottom sole of said mounting frame is curved to facilitate said mounting frame moving along a curved surface of the workpiece to be cut.

6. The plane recited in claim 5, wherein the curved underside of the bottom sole of said mounting frame includes an angled dishing ramp formed at the end of said mounting frame opposite said roller to facilitate said mounting frame moving along the curved surface of the workpiece.

7. The plane recited in claim 4, wherein the top side of the bottom sole of said mounting frame has a ramp face, said adjustable cutting blade carried by said mounting frame being slidable over said ramp face in response to a displacement of said cutting blade adjustment relative to said shaft.

8. The plane recited in claim 7, further comprising a lock down bar lying upon said adjustable cutting blade so as to apply a pressure against said cutting blade to hold said cutting blade against the ramp face of said mounting frame in order to prevent a displacement of said cutting blade over said ramp face.

9. The plane recited in claim 8, further comprising a dowel pin extending between the pair of side walls of said mounting frame, said lock down bar having a groove formed therein to capture said dowel pin and thereby position said hold down bar upon said adjustable cutting blade.

10. The plane recited in claim 8, further comprising a thumb screw having a threaded shaft received through a correspondingly threaded hole in said lock down bar, a rotation of said thumb screw causing the threaded shaft thereof to move towards and tighten against said adjustable cutting blade lying under said lock down bar to prevent a displacement of said cutting blade over said ramp face.

11. The plane recited in claim 1, wherein said adjustable blade adjustment coupled to said shaft is a threaded thumb nut axially aligned with said adjustable cutting blade, said shaft being threaded such that a rotation of said threaded thumb nut around said shaft causes an axial displacement of said thumb nut along said threaded shaft and a corresponding displacement of said cutting blade relative to said mounting frame in which said cutting blade is carried.

12. The plane recited in claim 11, including a series of index lines marked on said rotatable thumb nut and a reference line marked on said adjustable cutting blade to provide a visible indication of the rotation of said thumb nut around said threaded shaft and a corresponding indication of the displacement of said cutting blade relative to said mounting frame.

13. A plane for making cuts in a workpiece, said plane comprising:
a mounting frame to move along the workpiece to be cut, said mounting frame having a ramp face;
a roller attached to one end of said mounting frame and spaced from said ramp face to establish an exit slot, said roller adapted to roll over the workpiece to be cut;
a shaft projecting from the opposite end of the mounting frame to receive a pushing force for causing said mounting frame to move along the workpiece to be cut;
an adjustable cutting blade for making cuts in the workpiece along which the mounting frame is moved, said cutting blade being slidable over the ramp face of said mounting frame with respect to said exit slot;
a cutting blade adjustment coupled to said shaft, said cutting blame adjustment adapted to be displaced relative to said shaft for causing a corresponding displacement of said adjustable cutting blade over the ramp face of said mounting frame and towards said exit slot; and
a lock down bar lying upon said adjustable cutting blade so as to apply a pressure against said cutting blade to hold said cutting blade against the ramp face of said mounting frame in order to prevent a displacement of said cutting blade over said ramp face.
